(19) United States
(12) Patent Application Publication
(10) Pub. No.: US 2006/0136705 A1
(43) Pub. Date: Jun. 22, 2006

(54) Multiple stage software verification

(75) Inventors: Biju R. Kaimal, Emeryville, CA (US); Wayne H. Badger, Mahomet, IL (US); John D. Bruner, South Barrington, IL (US); Steve R. Bunch, Harvard, IL (US); Richard T. Chow, Santa Clara, CA (US); Boris Klots, Belmont, CA (US)

Correspondence Address: LAW OFFICES OF CHARLES W. BETHARDS, LLP, P.O. BOX 1622, COLLEYVILLE, TX, 76034, US

(73) Assignee: MOTOROLA, INC.

(21) Appl. No.: 11/018,595

(22) Filed: Dec. 21, 2004

(51) Int. Cl. G06F 9/24

(52) U.S. Cl. 713/2

(57) ABSTRACT

A communication unit (101) includes a transceiver (105) for communication over a communication network (107), and a processor (103). The processor (103) can install software components, including a first software component and a second software component. Responsive to a boot, the processor (103) can verifying the first software component against a first pre-determined value corresponding to at least the first software component; and subsequent to completion of the boot, verify the second software component against a second pre-determined value corresponding to at least the second software component.

### FIELD OF THE INVENTION

The present invention relates in general to computer software integrity, and more specifically to verification of computer software.

### BACKGROUND OF THE INVENTION

In today's computerized products, such as processors in cellular telephones, there can be provided a mechanism to verify that software currently in the processor has not been changed from the time it was originally flashed into the processor. This can be done in order to verify whether the software has been altered from the originally installed software. Accordingly, data and/or instructions on the processor can be protected from change.

In addition, software that is installed into the processor, such as an application, can be verified at installation time, e.g., in connection with a digital signature. Having been verified at installation time, such software typically is not re-verified.

It can be particularly desirable to verify sensitive material initially provided with the processor, such as an international mobile equipment identity (IMEI) or a master subsidy lock that prevents a cellular telephone from being reprogrammed to work with a different service provider. Moreover, it may be desirable that a processor on a device only load trusted software, e.g., to prevent malicious instructions from being installed.

There are a number of reasons why data and/or instructions on the processor could be changed. For example, software might be loaded onto a device with the processor and unfortunately not be valid or approved for the particular device. Hackers in the field could modify the software on the processor, or download an entirely different, perhaps malicious version of the software, and bypass higher-level security features such as passwords, subsidy locks, etc.

The mechanism currently provided for verification can be based on public key cryptography, such as a public key that resides in a one time programmable (OTP) memory area, and a portion of trusted software in the processor's boot read only memory (ROM) that verifies a digital signature of the boot flash image based on the public key. In addition, there can be provided data in the memory that identifies which area of flash memory is associated with the digital signature, and this piece of data is itself digitally signed. This mechanism works best with contiguous address spaces in flash memory and is most suitable when the boot flash image is built so that the parts to be verified are grouped together in the flash memory.

### BRIEF DESCRIPTION OF THE DRAWINGS

The accompanying figures, where like reference numerals refer to identical or functionally similar elements and which together with the detailed description below are incorporated in and form part of the specification, serve to further illustrate an exemplary embodiment and to explain various principles and advantages in accordance with the present invention.

FIG. 1 is a block diagram illustrating a simplified and representative environment associated with a communication unit and an exemplary communication network in accordance with various exemplary embodiments;

FIG. 2 is a flow diagram illustrating an exemplary multiple stage verification in accordance with various exemplary embodiments;

FIG. 3 is a flow diagram illustrating an exemplary trusted root public key for use in connection with one or more embodiments;

FIG. 4 is a block diagram illustrating portions of an exemplary communication unit in accordance with various exemplary embodiments;

FIG. 5 is a flow chart illustrating an exemplary staged boot verification procedure in accordance with various exemplary and alternative exemplary embodiments; and

FIG. 6 is a flow chart illustrating an exemplary on demand verification in accordance with various exemplary and alternative exemplary embodiments.

### DETAILED DESCRIPTION

In overview, the present disclosure relates to devices that can have software components, e.g., software (or a portion thereof) and/or data, loaded thereon. Such devices can include, for example, computers, and wireless communications devices or units, often referred to as communication units, such as cellular phones or two-way radios and the like that have an ability to have software loaded thereon either via a hard connection or over the air. Such devices can be associated with a communication system such as an Enterprise Network, a cellular Radio Access Network, or the like. Such communication systems may further provide services such as voice and data communications services. More particularly, various inventive concepts and principles are embodied in systems and methods therein for verifying software that can be loaded onto such a device.

The instant disclosure is provided to further explain in an enabling fashion the best modes of performing one or more embodiments of the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms such as first and second, and the like, if any, are used solely to distinguish one from another entity, item, or action without necessarily requiring or implying any actual such relationship or order between such entities, items or actions. It is noted that some embodiments may include a plurality of processes or steps, which can be performed in any order, unless expressly and necessarily limited to a particular order; i.e., processes or steps that are not so limited may be performed in any order.

As further discussed herein below, various inventive principles and combinations thereof are advantageously employed to verify software not only at boot time, but also after boot time. As a part of the boot process, or thereafter, software, e.g., computer instructions and/or digital data referenced by instructions, in a read-write portion of the flash memory can be verified against known good values, which have been provided to the process (e.g., written at installation time). Optionally, software which has been identified as critical can be verified at boot time, followed by a later evaluation of less critical software.

Further in accordance with exemplary embodiments, software can be verified later in a lazy evaluation, e.g., when processor time is sufficiently available. In accordance with alternative embodiments, software can be verified in an on demand approach. As another alternative embodiment, verification of software can be staged as the processor cycles through various stages from boot to normal operating procedure.

In a complex software environment, various parties can be involved in deploying software utilized on the processor. Operating system developers, operators, and application developers can be some of the various parties which are involved. In the interest of maintaining accountability, the various software can be provided with a digital signature or other pre-determined value to confirm that the software is genuine.

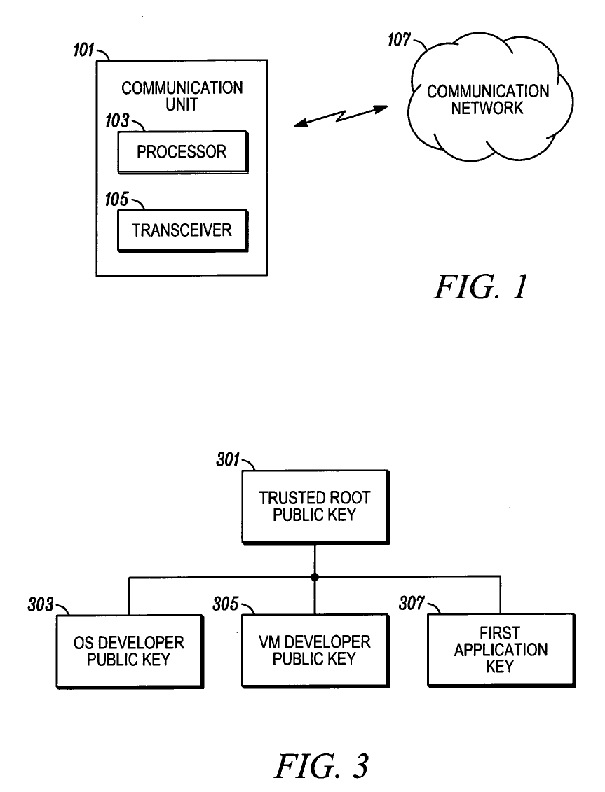

Referring now to FIG. 1, a block diagram illustrating a simplified and representative environment associated with a communication unit and an exemplary communication network in accordance with various exemplary embodiments will be discussed and described. The communication unit 101 is representative of various types of devices on which software can be provided, for use in connection with one or more embodiments. The communication unit 101 generally includes a processor 103, and in this example, a transceiver 105. It will be appreciated that alternative embodiments may include various other components for communication instead of or in addition to the transceiver 105, e.g., communication ports, transmitters and receivers.

The transceiver 105 can communicate with a communication network 107, including receiving software which can be installed on the processor 103. Where the communication unit 101 can connect in a wireless fashion, e.g., to a cellular communication network, the software can be received over the air via known protocols. Further, the communication unit 101 can connect to other types of communication networks in order to receive software.

Software that is installed can include, e.g., revised boot software, revised operating system, revised virtual machine, revised data, new and/or revised applications, etc.

The processor 103 can install software components, including a first software component and a second software component, in accordance with communication received over the transceiver 105. The software components that are received can be verified in accordance with one or more embodiments.

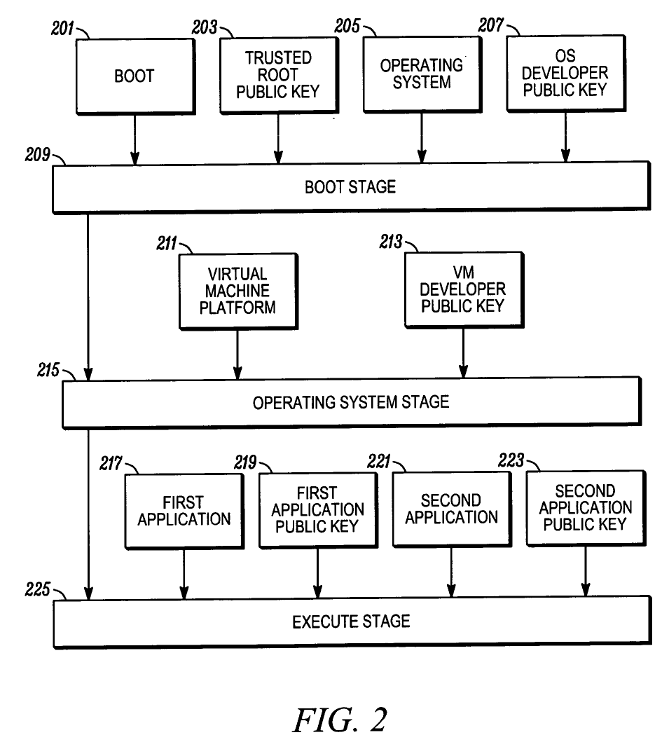

Referring now to FIG. 2, a flow diagram illustrating an exemplary multiple stage verification in accordance with various exemplary embodiments will be discussed and described. In overview, a processing flow commences with a boot stage 209, progresses to an operating system stage 215, and begins an execute stage 225. The boot stage 209 generally commences upon a power-up of a processor, or for example, upon a restart of the processor. One of skill in the art will appreciate the various techniques that can be employed to provide the boot stage 209, the operating system stage 215, and the execute stage 225. Generally, the boot stage 209 provides for boot strapping a limited set of software, which can then be utilized to load in a more complete set of operating system software. The operating system stage can be provided for as a separate part of the boot software, and/or can be performed by operating system initiation procedures. Once the operating system is prepared, normal operating procedures can be followed in the execute stage 225.

In the illustrated example, the boot stage 209 initially can retrieve the boot software 201 (e.g., from PROM) and (optionally) can retrieve a pre-determined value corresponding to the boot software. The pre-determined value can be, for example, a digital signature calculated using a key pair, a hash value, a cyclic redundancy check (CRC) character, or other value utilized for verifying that the boot software is accurate. The pre-determined value can be compared with the boot software 201 as is appropriate for the type of the value. For example, where the pre-determined value is a digital signature 203, the boot software 201 can be checked for an appropriate encoding of the public key.

In addition, the boot stage 209 can provide for a verification of a software component that is to be executed next. For example, the operating system 205 typically is executed following the boot stage 209. Accordingly, the boot stage can verify the first software component, against a pre-determined value that corresponds to the first software component. The pre-determined value can be, as detailed above, a digital signature calculated using a key pair, e.g., an operating system developer key pair 207, a hash value, a CRC character, etc.

The boot stage 209 progresses to an operating system stage 215. As explained previously, the operating system stage 215 can overlap with the boot stage 209, can be performed at least partially by the boot stage, or can commence upon termination of the boot stage 209. The operating system stage 215 can provide for a verification of a software component that is to be executed next. For example, a virtual machine platform 211 may be initiated after the operating system stage 215 is successful. Accordingly, the operating system stage 215 can verify the second software component against a pre-determined value that corresponds to the second software component. The pre-determined value can be, as detailed above, a digital signature calculated using a key pair, e.g., a virtual machine developer key pair 213, a hash value, a CRC character, etc.

The operating system stage 215 progresses to an execute stage 225. As outlined above, the execute stage generally is initiated once the operating system stage 215 is complete, or one portion of the operating system is sufficiently operable. The execute stage 225 can provide for a verification of a software component that is to be executed next. For example, one or more applications, e.g., first application and second application 217, 221 can be initiated after the operating system stage 215 is successful. Accordingly, the execute stage 225 can verify the additional software components against a pre-determined value that corresponds to the respective software components. The pre-determined value can be, as detailed above, a digital signature calculated using a key pair, e.g., respective first application key pair 219 and second application key pair 223, a hash value, a CRC character, etc.

In accordance with one or more embodiments, the software (or portions thereof) in a read-write portion of the flash memory is verified against a known good value which was previously written, e.g., at installation time. For example, pre-determined portions of the software can be verified during the boot stage, followed by a lazy evaluation of other portions of the software, e.g., on-demand verification, and/or verification as processor time becomes available, and or verification in a staged approach. Each of these variations is discussed in more detail below.

Referring now to FIG. 3, a flow diagram illustrating an exemplary trusted root public key for use in connection with one or more embodiments will be discussed and described. In using key pairs, a digital signature corresponding to a software component can be verified by using the certificate corresponding to the key pair that created the signature. In addition, the certificate that signed the software component can be verified against the issuing certificate.

For example, the operating system can have a corresponding operating system developer public key 303, the virtual machine platform can have a corresponding virtual machine developer public key 305, and/or the first application can have a first application public key 307. The certificate itself can have a digital signature, which can be validated in turn by checking the public key corresponding to the digital signature against the certificate of the authority that issued it. This process can be repeated up to the trusted root public key 301. The root public key should be from a source that is known to be trusted. In accordance with one or more embodiments, the known trusted source can be specified, e.g., in the boot software.

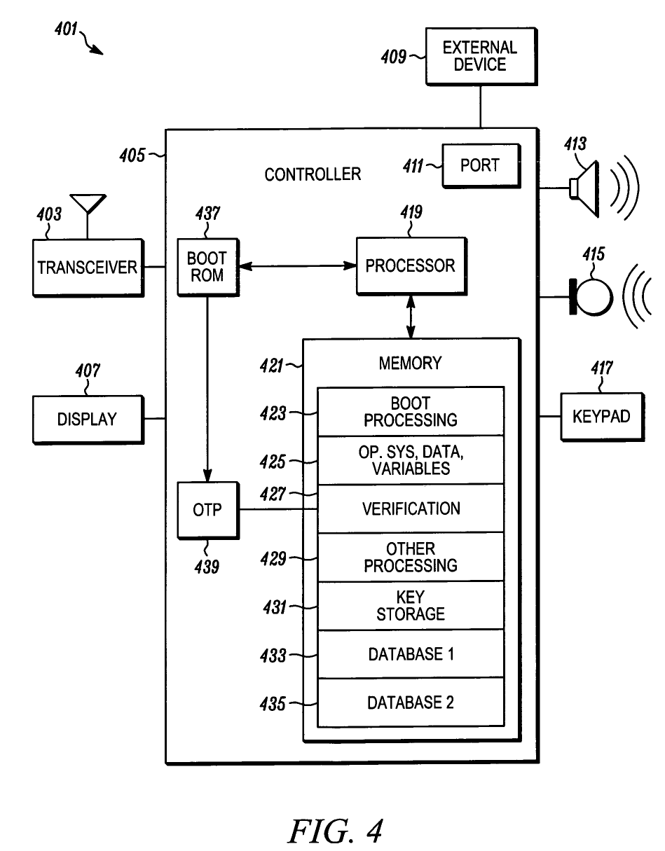

Referring now to FIG. 4, a block diagram illustrating portions of an exemplary communication unit in accordance with various exemplary embodiments will be discussed and described. Although a communication unit 401 is depicted and discussed in the present example, it will be appreciated that one or more embodiments can be operated in connection with processors utilized in connection with other types of devices not limited to the communication industry. The communication unit 401 may include one or more controllers 405, a transceiver 403, and a communication port 411 for communication with an external device 409. The controller 405 as depicted generally includes a processor 419, and a memory 421, and may include other functionality not illustrated for the sake of simplicity. The communication unit 401 may further include, e.g., a speaker 413, a microphone 415, a text and/or image display 407, an alerting device (not illustrated) for providing vibratory alert, visual alert, or other alert, and/or a user input device such as a keypad 417. The transceiver 403 can be capable of receiving communications when operably connected to a communication network.

The processor 419 may comprise one or more microprocessors and/or one or more digital signal processors. The memory 421 may be coupled to the processor 419 and may comprise a read-only memory (ROM), a random-access memory (RAM), a programmable ROM (PROM), and/or an electrically erasable read-only memory (EEPROM), etc. The memory 421 may include multiple memory locations for storing, among other things, boot processing 423, an operating system, data and variables 425 for programs executed by the processor 419; computer programs for causing the processor to operate in connection with various functions such as verification 427, and/or other processing 429; a database 433 of various pre-determined values, e.g., public keys and identifications of corresponding software; and a database 435 for other information used by the processor 419. The computer programs may be stored, for example, in ROM or PROM and may direct the processor 419 in controlling the operation of the communication device 401. The processor also can comprise a boot ROM 437 and a one time programmable (OTP) memory 439. The processor 419 may be programmed to facilitate installing software components including at least a first software component and at least a second software component in accordance with communications received via the transceiver 403.

The display 407 may present information to the user by way of a conventional liquid crystal display (LCD) or other visual display, and/or by way of a conventional audible device (e.g., the speaker 413) for playing out audible messages.

The user may invoke functions accessible through the user input device 417. The user input device 417 may comprise one or more of various known input devices, such as a keypad as illustrated, a computer mouse, a touchpad, a touch screen, a trackball, and/or a keyboard. Responsive to signaling from the user input device 417, or in accordance with instructions stored in memory 421, the processor 419 may direct or manage stored information or received information. For example, in response to power up, the processor 419 can be programmed to execute or operate boot instructions, resulting in booting of the processor.

In response to a power up or other action resulting in a boot of the processor 419, the processor 419 can first verify at least the first software component against a first predetermined value corresponding to at least the first software component. Subsequent to completion of the boot, the processor 419 can second verify at least the second software component against a second pre-determined value corresponding to at least the second software component. As is known to one of skill, a boot typically consists of a first stage and a second stage. The first stage of a boot is executed from the boot ROM 437 in communication with the processor 419. The boot stage code can be immutable after the communication device is manufactured. When the first stage is sufficiently complete, the second stage of the boot is performed, e.g., by the boot processing 423 in the memory 421.

The pre-determined values can be verified in connection with a trusted value. One convenient place for storing the trusted value is the OTP 439. The OTP 439 can provide storage, advantageously which can be write locked after being written with, e.g., the trusted value utilized to verify various software components. The OTP can store the trusted root public key, discussed in connection with FIG. 3. One or more embodiments provide that a digital signature can be verified by checking the public key corresponding to the digital signature against the certificate of the authority that issued it, up through a trust chain that ends at the trusted root public key, e.g., stored in the OTP 439.

As explained previously, software components can include e.g., revised boot software 423, revised or new operating system 425, revised or new virtual machine, revised or new data, new and/or revised applications, and/or components, and/or data utilized by the processor 419. Further, the software components can be a portion of the foregoing, e.g., an updated portion, a new portion, a patch process to correct one of the foregoing.

In accordance with one or more embodiments, various exemplary embodiments of the second verifying can be provided. Various embodiments and alternative embodiments can include, e.g., on-demand verification, and/or verification as processor time becomes available, and/or verification in a staged approach.

In accordance with one or more on-demand verification embodiments, the second verifying can be responsive to an execution of at least the second software component. For example, a fault can be generated upon execution of the second software component, e.g., an application program. Optionally, either before or after generating the fault, it can be determined whether the second software component was previously verified, such as by checking a table, and skipping a verification if the second software component was previously verified. (Previously verified can include, for example, verified after the most recent boot, verified upon installation, or verified after installation.) According to optional embodiments, the second verifying further comprises, if the second software component has not been previously verified, generating a fault upon execution of the second software component, and responsive to the fault, determining whether the second software component verifies or validates.

In accordance with one or more embodiments, the second verifying can be responsive to an availability of processor time. For example, a table can be stored identifying the second software component and any other software components which remain to be verified. (Optionally, it can be provided that only specified software components are verified.) When the processor 419 is sufficiently idle from time to time, e.g., as measured by a process monitor, the second software component, or other remaining software components, can be verified.

In accordance with one or more embodiments, the second verifying can be performed in a staged manner. For example, the second verifying can be responsive to a load of an operating system 425. As will be understood by one of skill, the operating system 425 conventionally can be loaded by the boot portion 423, typically before the boot portion 423 transfers control to the program that is conventionally defined next to take control. Accordingly, the operating system 425 can be verified in responsive to a load thereof, either just before or after being loaded.

As another example of the second verifying being performed in a staged manner, such that the first verifying can verify a first portion of the software components and execution of the first portion can be initiated responsive to the first verifying, and wherein the first portion facilitates initiation of a second portion of the software components including the second software component. The second verifying can be responsive to initiation of the second portion. Where the second software component initiates execution of a third (or subsequent) software component, a third verifying can be performed in response to initiation of the third component.

Advantageously, the verifying can be performed utilizing one or more key pairs, in accordance with known techniques, as previously described. Accordingly, the processor 419 can access the key storage 431 to obtain key pairs utilized in connection with the pre-determined values of the verification. One or more key pair can be provided specific to the processor 419 or the communication device 401, wherein the pre-determined value corresponds to the key pair.

One or more embodiments can provide that the processor 419 facilitates, when at least one of the first verifying and the second verifying fails, performing error processing. Appropriate error processing can include, for example, powering down the communication device 401, providing an error indication to the user, e.g., on the display 407, providing an error communication via the communication network in accordance with the transceiver 403, not executing the unverified software component, and/or updating the software component that failed verification. Error processing can be provided corresponding to the stage of verification, if desired. For example, a failure of the operating system to verify may be associated with one type of error processing, while a failure of an application program may be associated with another type of error processing.

According to one or more embodiments, the processor 419 can be configured to facilitate, responsive to a boot thereon, first verifying a first software component against a first pre-determined value corresponding to the first software component; and responsive to an execution of a second software component, second verifying at least the second software component against a second pre-determined value corresponding to at least the second software component. According to one or more embodiments, the first software component includes an operating system 425 and the second software component includes one or more application programs.

The first software component and/or the second software component that will be verified as above can be installed in the processor 419 in accordance with communications received over the transceiver 403. As described previously in detail, the transceiver can receive communications when operably connected to a communication network. The processor 419 can facilitate installing software components including the first software component and the second software component in accordance with communication received over the transceiver. The first verifying can be performed at boot stage and the first software component can include at least a portion of the operating system; the second verifying can be performed at an operating system stage and the second software component can include at least a virtual machine program, e.g., such as a virtual machine platform available under the trademark JAVA.

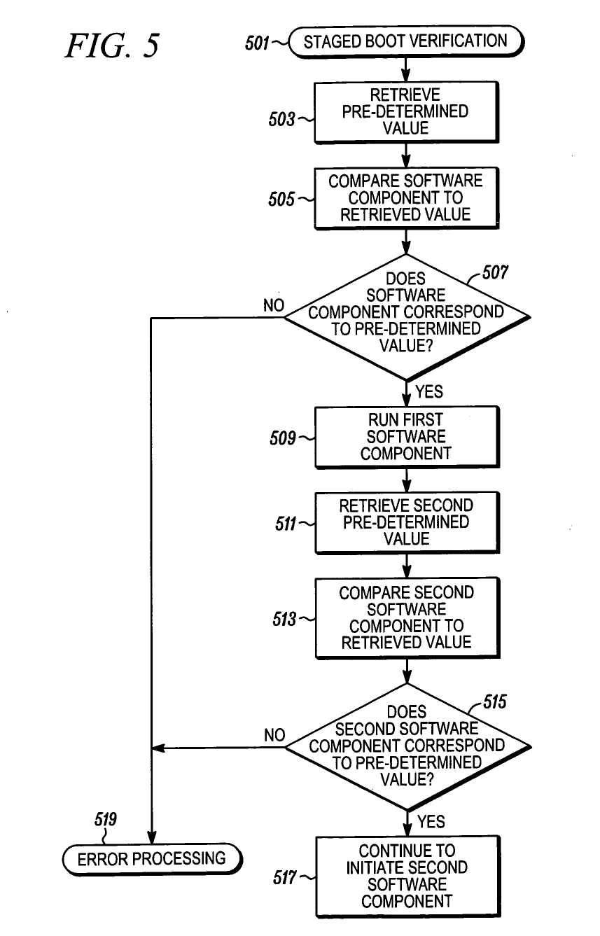

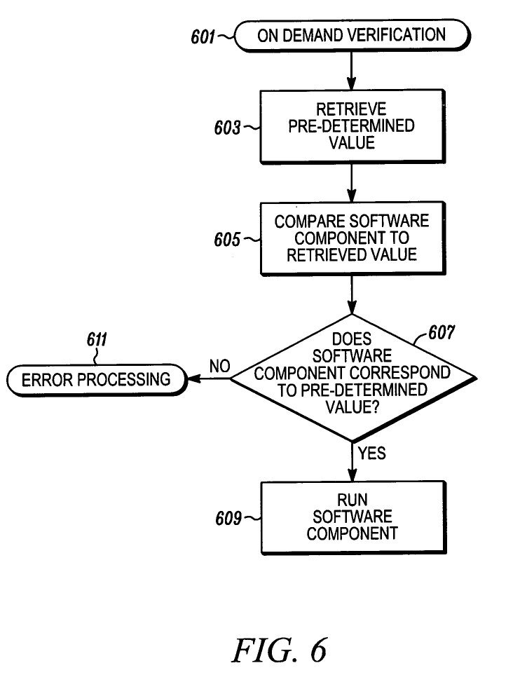

FIG. 5 and FIG. 6 provide illustrations of two exemplary embodiments of verification, e.g., a staged boot verification procedure and an on-demand verification procedure, respectively. These exemplary embodiments may be utilized independently, and/or can be utilized in combination.

In accordance with a staged boot verification procedure, a lowest layer of software can verify and initiates execution of the next immediate layer in the hierarchy. For example, the lowest layer may be the code in the processor which verifies the operating system and brings the operating system up, and the operating system can verify the platform code and initiate execution of the platform code. Memory required for verification can be appropriately limited to the size of the software being verified. Referring now to FIG. 5, a flow chart illustrating an exemplary staged boot verification procedure 501 in accordance with various exemplary and alternative exemplary embodiments will be discussed and described. The procedure can advantageously be implemented on, for example, a processor of a controller, described in connection with FIG. 4 or other apparatus appropriately arranged. A staged boot verification 501 procedure, in the illustrated example, can retrieve 503 the first pre-determined value. Then, the procedure can compare 505 the first software component to the retrieved value. If the software component, determined as discussed above, does not correspond to the pre-determined value at 507, then error processing 519 can be performed.

Assuming the first software component verifies, then the first software component is run 509, optionally including loading the first software component and/or transferring control to the first software component. The process, which is now controlled by the first software component, then retrieves the second pre-determined value 511, and compares 513 the second software component to the retrieved value. If the second software component, determined as noted earlier, does not correspond to the pre-determined value at 515, then error processing 519 can be performed. Assuming, however, that the second software component verifies, then the process continues 517 to initiate the second software component.

A verification table can provide a software component identification, and a pre-determined value such as a hash or other value corresponding thereto. The verification table can itself be protected, e.g., by a hash or other pre-determined value corresponding thereto. Advantageously, the pre-determined value can be determined at least in part by the content of its corresponding table or software component. When particular software is installed into the processor, or is provided for installation, the pre-determined value corresponding thereto can be written into the verification table. If appropriate, the pre-determined value corresponding to the verification table can be redetermined and stored.

Since verifying smaller and potentially discontinuous portions of memory can be more time consuming that verifying large continuous blocks of memory, an on-demand approach can be utilized for verification. Referring now to FIG. 6, a flow chart illustrating an exemplary on demand verification 601 in accordance with various exemplary and alternative exemplary embodiments will be discussed and described. The procedure can advantageously be implemented on, for example, a processor of a controller, described in connection with FIG. 4 or other apparatus appropriately arranged.

An on demand verification 601 process can be initiated in response to a demand for the particular software that is to be verified. For example, as described above, the on demand processing can be responsive to a fault generated when the program is initiated. The on demand verification 601 can provide for retrieving 603 the predetermined value corresponding to the software component that is to be loaded. The process compares 605 the software component to the retrieved value. If the software component, derived or determined as noted earlier, does not correspond to the pre-determined value at 607, then error processing 611 can be performed. Assuming, however, that the software component verifies, then the process continues 609 to run the software component.

One or more embodiments can be used in connection with, for example, secure technology implemented on communication devices, as well as processors utilized in connection with other types of devices not limited to the communication industry. Moreover, one or more embodiments can be utilized in connection with various public key infrastructure tools and digital signature services.

Much of the inventive functionality and many of the inventive principles when implemented, are best supported with or in software or integrated circuits (ICs), such as a digital signal processor and software therefore or application specific ICs. Where appropriate, the processor can be, for example, a general purpose computer, can be a specially programmed special purpose computer, can include a distributed computer system, and/or can include embedded systems. Similarly, where appropriate, the processing could be controlled by software instructions on one or more computer systems or processors, or could be partially or wholly implemented in hardware. It is expected that one of ordinary skill, notwithstanding possibly significant effort and many design choices motivated by, for example, available time, current technology, and economic considerations, when guided by the concepts and principles disclosed herein will be readily capable of generating such software instructions or ICs with minimal experimentation. Therefore, in the interest of brevity and minimization of any risk of obscuring the principles and concepts according to the present invention, further discussion of such software and ICs, if any, will be limited to the essentials with respect to the principles and concepts used by the preferred embodiments.

It should be noted that the term communication unit may be used interchangeably herein with subscriber unit, wireless subscriber unit, wireless subscriber device or the like. Each of these terms denotes a device ordinarily associated with a user and typically a wireless mobile device that may be used with a public network, for example in accordance with a service agreement, or within a private network such as an enterprise network. Examples of such units include personal digital assistants, personal assignment pads, and personal computers equipped for wireless operation, a cellular handset or device, or equivalents thereof provided such units are arranged and constructed for operation in different networks.

The communication systems and communication units of particular interest are those providing or facilitating voice communications services or data or messaging services over cellular wide area networks (WANs), such as conventional two way systems and devices, various cellular phone systems including analog and digital cellular, CDMA (code division multiple access) and variants thereof, GSM (Global System for Mobile Communications), GPRS (General Packet Radio System), 2.5G and 3G systems such as UMTS (Universal Mobile Telecommunication Service) systems, Internet Protocol (IP) Wireless Wide Area Networks like 802.16, 802.20 or Flarion, integrated digital enhanced networks and variants or evolutions thereof.

Furthermore the wireless communication units or devices of interest may have short range wireless communications capability normally referred to as WLAN (wireless local area network) capabilities, such as IEEE 802.11, Bluetooth, or Hiper-Lan and the like preferably using CDMA, frequency hopping, OFDM (orthogonal frequency division multiplexing) or TDMA (Time Division Multiple Access) access technologies and one or more of various networking protocols, such as TCP/IP (Transmission Control Protocol/Internet Protocol), UDP/UP (Universal Datagram Protocol/Universal Protocol), or other protocol structures. Alternatively the wireless communication units or devices of interest may be connected to a LAN using protocols such as TCP/IP, UDP/UP, IPX/SPX, or Net BIOS via a hardwired interface such as a cable and/or a connector.

This disclosure is intended to explain how to fashion and use various embodiments in accordance with the invention rather than to limit the true, intended, and fair scope and spirit thereof. The invention is defined solely by the appended claims, as they may be amended during the pendency of this application for patent, and all equivalents thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. A communication unit comprising:
a transceiver, the transceiver being capable of receiving communications when operably connected to a communication network;
a processor, the processor being configured to facilitate installing a plurality of software components including at least a first software component and at least a second software component in accordance with communications received over the transceiver; responsive to a boot, first verifying at least the first software component against a first pre-determined value corresponding to at least the first software component; and subsequent to completion of the boot, second verifying at least the second software component against a second pre-determined value corresponding to at least the second software component.

2. The communication unit of claim 1, wherein the plurality of software components include at least one of at least a portion of an operating system and at least a portion of an application program.

3. The communication unit of claim 1, wherein the second verifying is responsive to an execution of at least the second software component.

4. The communication unit of claim 3, wherein the second verifying further comprises, if at least the second software component has not been previously verified, generating a fault upon execution of at least the second software component; and responsive to the fault, determining whether at least the second software component verifies.

5. The communication unit of claim 1, wherein the second verifying is responsive to an availability of processor time.

6. The communication unit of claim 1, wherein the second verifying is responsive to a load of an operating system.

7. The communication unit of claim 1, wherein the first verifying verifies a first portion of the plurality of software components and execution of the first portion is initiated responsive to the first verifying, wherein the first portion facilitates initiation of a second portion of the plurality of software components including at least the second software component; and the second verifying is responsive to initiation of the second portion.

8. The communication unit of claim 1, further comprising at least one key pair specific to the processor, wherein the pre-determined value corresponds to the key pair.

9. The communication unit of claim 1, wherein the processor is further configured to facilitate, when at least one of the first verifying and the second verifying fails, performing error processing.

10. A method for performing a multi-stage verification, performed in a communication unit, comprising:
responsive to a boot in a processor, first verifying at least a first software component against a first pre-determined value corresponding to at least the first software component; and
responsive to an execution of at least a second software component, second verifying at least the second software component against a second pre-determined value corresponding to at least the second software component.

11. The method of claim 10, wherein the first verifying at least the first software component further includes verifying at least an operating system and the second verifying at least the second software component further includes verifying at least an application program.

12. The method of claim 10, wherein the second verifying further comprises, if at least the second software component has not been previously verified, generating a fault upon execution of at least the second software component; and responsive to the fault, determining whether at least the second software component verifies.

13. The method of claim 10, further comprising providing at least one key pair specific to the processor, wherein at least one of the first and the second pre-determined value corresponds to the key pair.

14. The method of claim 10, further comprising, when at least one of the first verifying and the second verifying fails, performing error processing.

15. The method of claim 10, further comprising installing a plurality of software components including at least the first software component and at least the second software component in accordance with a communication received via a transceiver.

16. A communication unit comprising:
a processor, the processor being configured to facilitate, responsive to a boot, first verifying at least a first software component against a first pre-determined value corresponding to at least the first software component, and initiating execution of at least the first software component, wherein the first portion facilitates initiation of at least a second software component; and responsive to initiation of at least the second software component, second verifying at least the second software component against a second pre-determined value corresponding to at least the second software component.

17. The communication unit of claim 16, wherein the first verifying is performed at boot stage and at least the first software component includes at least a portion of the operating system; and wherein the second verifying is performed at an operating system stage and at least the second software component includes at least a virtual machine program.

18. The communication unit of claim 16, wherein at least the first software component includes an operating system and at least the second software component includes an application program.

19. The communication unit of claim 16, further comprising at least one key pair specific to the processor, wherein the predetermined value corresponds to the key pair.

20. The communication unit of claim 16, wherein the processor is further configured to facilitate, when at least one of the first verifying and the second verifying fails, performing error processing.
